(19) United States
(12) Patent Application Publication
(10) Pub. No.: US 2015/0220862 A1
(43) Pub. Date: Aug. 6, 2015

(54) SYSTEM AND METHOD FOR AUTOMATED EVALUATION OF CUSTOMER ACTIVITY

(71) Applicant: Fraud Sniffr, Inc., Sparks, MD (US)

(72) Inventors: Curt De Vries, Jenison, MI (US); Marci De Vries-Todtz, Sparks, MD (US)

(21) Appl. No.: 14/456,001

(22) Filed: Aug. 11, 2014

Related U.S. Application Data
(60) Provisional application No. 61/935,922, filed on Feb. 5, 2014.

(51) Int. Cl. G06Q 10/06; G06F 17/30

(52) U.S. Cl. CPC G06Q 10/0635; G06F 17/30864; G06F 17/301; G06F 17/3053; G06F 17/30516; G06Q 40/08; G06Q 50/01

(57) ABSTRACT

Disclosed is a system and method for monitoring and evaluating customer behavior, as evidenced by a customer's postings in their social media profile(s), in order to detect, collect, and report the existence of evidence that representations made by the customer of a service provider were potentially fraudulent. The monitoring and evaluation is carried out on an automated, continuous basis in real time, thus capturing all activity of the customer (as evidenced in their social media profile) and providing a better view of the customer's activities than has been available from the manual, sporadic monitoring that has been practiced in the prior art. Further, as the monitoring and evaluation is conducted of only the postings in a designated, individual customer's social media profile(s), the volume of data that undergoes such analysis is limited, making the method and system far more manageable and more easily implemented than “big data” solutions that scour full websites, or even the Internet as a whole, in an effort to find less relevant information than that which is investigated by the instant invention.

### CROSS REFERENCE TO RELATED APPLICATIONS

This application is based upon and claims priority from co-pending U.S. Provisional Patent Application Ser. No. 61/935,922 entitled “SYSTEM AND METHOD FOR AUTOMATED DETECTION OF INSURANCE FRAUD” filed with the U.S. Patent and Trademark Office on Feb. 5, 2014, by the inventors herein, the specification of which is incorporated herein by reference.

### FIELD OF THE INVENTION

The present invention relates to the automated, continuous, real time evaluation of customer activity, and more particularly to systems and methods configured to continuously monitor a service provider's customers' social media profiles in real time to identify and collect statements by the customer indicating conditions contrary to information represented by the customer to the service provider and relevant to the service provided by the service provider to the customer, and to generate output that reports such contrary conditions in a verifiable data format that confirms the veracity of such output.

### BACKGROUND

Fraud, throughout various industries, creates additional costs, service inefficiencies, and a variety of other problems. For example, workers' compensation and casualty insurance fraud and abuse are significantly pervasive problems, are widespread, and cost insurance providers more than $5 billion every year. As this creates significant, unnecessary expenses that must either be absorbed by insurers or, more commonly, passed on to customers, a need exists that will allow insurers to detect and mitigate fraudulent activity. Similarly, fraudulent representations made by consumers of financial products result in the creation of loans at greater risk of default, wire transfers to terrorist organizations, and theft of financial assets, which raise costs and legal risks for lending institutions and ultimately the customers they serve.

Social media provides large volumes of information about individuals. For example, people discuss their own activities, their vacations, and the like, at times bragging and boasting about those activities and the wonderful times that they enjoy. Their social media profiles can, in essence, create an electronic lifestyle and behavioral profile. Moreover, that profile may describe activities that a particular insurance claimant should not be able to participate in if in fact their injury or illness that is the subject of their insurance claim is legitimate. Likewise, that profile may describe activities of or circumstances relating to a loan applicant or other financial product consumer that might suggest that such consumer does not have the financial wherewithal to support a particular loan payment. Further, that profile may inform whether or not wire transfers are being made to terrorist organizations, and may likewise indicate purchases of products or services that would ordinarily be unaffordable for an individual, suggesting potential embezzlement or the like.

Previous efforts have been made to use social media profiles to detect potentially fraudulent activity and representations, which have required humans to manually screen social media data, in turn giving a limited temporal snapshot of data about the claimant (often locating information available on social media on the particular day that the human performed the scan). This activity has required costly human labor (often incurring an expense of $200-$300 per claimant), and often reveals nothing helpful or indicative of potential fraud. Due to the labor intensive effort of such human-managed screening, such screening is typically limited to only those minimal portions of the individual's social media profile that are accessible at the time the searcher is looking, instead of a continuous, real-time screening of all postings that they generate. In short, such human, manual analysis comprises a search for a proverbial needle in a haystack.

Some software has been developed previously to automate the scanning process; however, this software delivers all data available, which includes irrelevant data such as contest entries, reposts of information, and “quote of the day” items that are immaterial to a fraud case. The overwhelming nature of this data output proved to be as unuseful as searching manually. This data is delivered in an unstructured format, and is difficult to manage across the enterprise.

Other software has been developed that pulls data from the entirety of social media and provides aggregate statistics about sentiment in general. This software has been used to gather information about all people using social media who have the same name as the individual of interest. This ‘big data solution’ is not useful for tracking individual customer behavior and providing insight into the commission of personal fraud, because it cannot be limited to an individual's personal behavior.

Thus, there remains a need in the art for an automated system that provides broader visibility into claimants' activities and overall behavior in order to have greater opportunity to detect fraud, while also limiting the information delivered to investigators so that only information relevant to the issue at hand is presented. In order for the data to be useful to enterprise businesses, the data delivered should be structured into a searchable, sortable, downloadable database for use and consistency across multiple customers. The solution also should be able to integrate with the enterprise customer management software used by any enterprise. Further, the data delivered should be provided in a verifiable data format, such that the veracity of the data may be established in a legal proceeding, such as an insurance fraud investigation and hearing, a criminal embezzlement case, and the like.

### SUMMARY OF THE INVENTION

Disclosed is a system and method for monitoring and evaluating customer behavior, as evidenced by a customer's postings in their social media profile(s), in order to detect, collect, and report the existence of evidence that representations made by the customer of a service provider were potentially fraudulent. The monitoring and evaluation is carried out on an automated, continuous basis in real time, thus capturing all activity of the customer (as evidenced in their social media profile) and providing a better view of the customer's activities than has been available from the manual, sporadic monitoring that has been practiced in the prior art. The system also filters all social media data gathered about a customer to eliminate all data that is irrelevant to the case against the customer, which provides an improved result over the “all data” solution practiced in the prior art. The data collected and delivered to the service provider is simultaneously captured in a database that is searchable, sortable, downloadable, and able to be integrated into the enterprise customer management software of the service provider.

Further, as the monitoring and evaluation is conducted of only the postings in a designated, individual customer's social media profile(s), the volume of data that undergoes such analysis is limited to the individual's behavior, making the method and system far more manageable and more easily implemented than “big data” solutions that scour full websites, or even the Internet as a whole, in an effort to find less relevant information than that which is investigated by the instant invention.

In exemplary embodiments of the invention, the method and system are used in the context of insurance fraud detection and financial fraud detection, in which the postings in a claimant's social media profile are evaluated on an automated, continuous basis in real time. After the software is attached to the individual's social media profile, all of the individual's content is downloaded into a database. The data is then filtered using natural language queries to locate all items of interest to the fraud investigation in this unstructured data set, which includes text links, photos, videos and the like. The items of interest are then shown via the service provider's interface, where the results are searchable, sortable and downloadable. The search query logic is designed to identify information in individuals' posts that may indicate potential fraud. Those queries are continuously run against the postings in a claimant's social media profile, and posts that are responsive to those queries are captured in full, including the posts' metadata, and copied to a digest of hits/responses associated with that claimant. Those posts may then be reviewed by the insurance adjuster responsible for that claimant's claim to determine whether the captured postings do, in fact, suggest fraud on the part of the claimant. Moreover, by capturing the metadata associated with the posts, reports detailing those posts suggesting fraud may be verified for their veracity, and thus may be used as trusted evidence in a legal proceeding (such as an insurance fraud investigation and hearing).

With regard to aspects of an embodiment of the invention, a computer implemented service provider customer evaluation system is provided comprising a computer implemented monitoring engine having computer software code configured to: (i) receive electronic queries formatted to identify information in electronic posts within an electronic social media profile that is uniquely associated with a specific customer of a service provider, which information is contrary to information represented by the customer to the service provider and relevant to a service provided by the service provider to the customer; (ii) continuously apply the queries to posts in the customer's social media profile; (iii) receive responses to the queries of the posts in the customer's social media profile, the responses comprising one or more posts in the customer's social media profile containing information that is responsive to at least one of the queries; (iv) capture metadata associated with the responses to provide proof of the source of the post and the date on which it was generated in legal proceedings; and (v) generate a listing of the responses to the queries. In accordance with one aspect of an embodiment of the invention, the listing of responses to the queries is searchable, sortable, downloadable and can be integrated into any service provider's CRM.

With regard to another aspect of an embodiment of the invention, a computer implemented method for evaluating customers of a service provider is provided, comprising the steps of: (i) receiving at a computer implemented monitoring engine queries formatted to identify information in electronic posts within an electronic social media profile, which social media profile is uniquely associated with a specific customer of a service provider, which information is contrary to information represented by the customer to the service provider and relevant to a service provided by the service provider to the customer; (ii) causing the monitoring engine to continuously apply the queries to posts in the customer's social media profile; (iii) receiving at the monitoring engine responses to the queries of the posts in the customer's social media profile, the responses comprising one or more posts in the customer's social media profile containing information that is responsive to at least one of the queries; (iv) capturing metadata associated with the responses to provide proof of the source of the post and the date on which it was generated in legal proceedings; and (v) generating a listing of the responses to the queries. In accordance with one aspect of an embodiment of the invention, the listing of responses to the queries is searchable, sortable, downloadable and can be integrated into any service provider's CRM.

### BRIEF DESCRIPTION OF THE DRAWINGS

Various features and advantages of the disclosure will become more apparent by the following detailed description of several embodiments thereof with reference to the attached drawings, of which:

FIG. 1 is a schematic view of a system for evaluating customers of a service provide in accordance with certain aspects of an embodiment of the invention.

FIG. 2 is an exemplary customer or claimant profile setup screen that may be generated by the system of FIG. 1.

FIG. 3 is an exemplary customer or claimant individual monitoring page that may be generated by the system of FIG. 1.

FIG. 3a is an exemplary full post display page that may be generated by the system of FIG. 1.

FIG. 3b is an exemplary full post display page including a display of the metadata associated with the post.

FIG. 4 is an exemplary service provider employee (e.g., an insurance adjuster) user interface screen that may be generated by the system of FIG. 1.

FIG. 4a is another exemplary service provider employee user interface screen.

FIG. 5 is an exemplary manager user interface screen that may be generated by the system of FIG. 1.

FIG. 6 is method for evaluating customers of a service provider in accordance with certain aspects of an embodiment of the invention.

### DETAILED DESCRIPTION OF THE PREFERRED EMBODIMENTS

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Disclosed herein is an automated, computer-implemented system that provides the continuous, real time automated scanning of social media profiles of customers of service providers, such as insurance claimants, financial product consumers, or any other person(s) that are expected to make truthful representations to a service provider as a condition for receiving the particular service, across multiple electronic social media platforms, providing increased validity of visible surveillance by tying the surveillance to the customer's overall behavior. As used herein, “real time” monitoring is intended to mean automated, ongoing, continuous monitoring of a single, individual social media profile that may be carried out pursuant to a preset schedule at which automated queries are run against a user's social media profile, whether once per second, once per hour, or some fraction or multiple thereof, as opposed to an individual human's monitoring of such a single, individual social media profile that inherently must be interrupted as the human monitor undertakes other activities. In order to manage the collection of responses to natural language queries generated by the system, the natural language queries are run against only the electronic postings in an individual customer's social media profile, and only those postings that are responsive to the natural language search queries (e.g., that include information that is potentially indicative of fraud) are collected and archived.

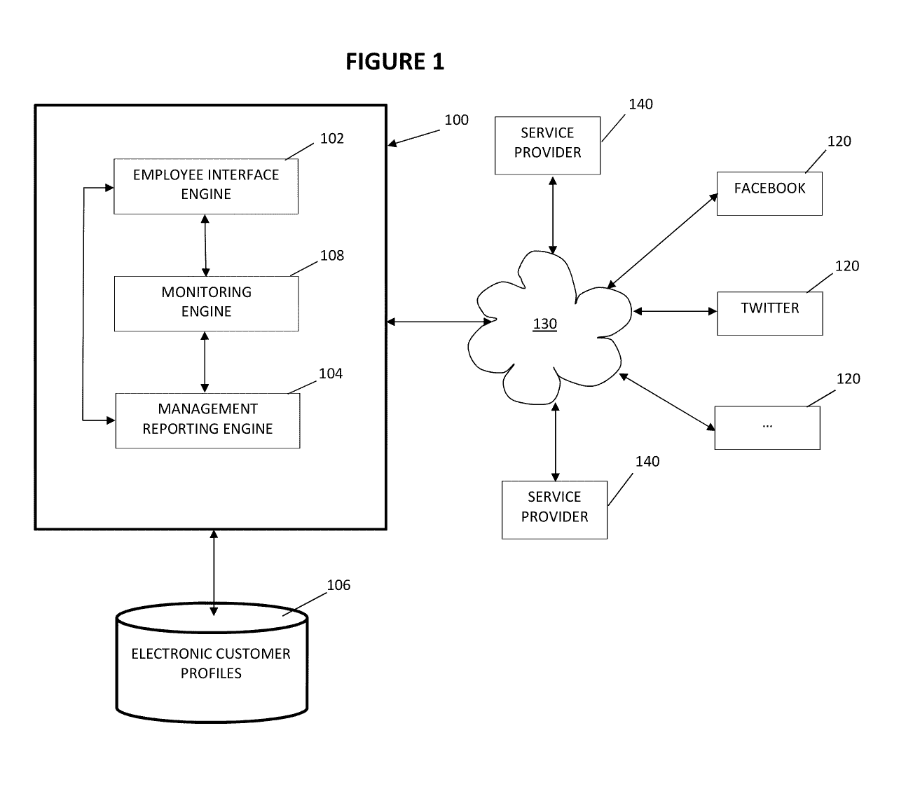

As shown in FIG. 1, the system comprises an automated computer-implemented customer monitoring system 100, executable for example on a server computer, in a cloud-based SAAS implementation, etc., which monitoring system 100 may be accessed by employees of the service provider at multiple companies 140 in order to monitor the electronic social media profiles of multiple customers.

For ease of description of certain aspects of the invention, an embodiment of the system and method is described as an insurance provider claimant monitoring system 100 accessed by, for instance, insurance adjusters at multiple insurance companies 140, although those skilled in the art will recognize that such system is exemplary only and adaptable to other service providers that rely on the accuracy of representations made by their customers as a condition to rendering their service (e.g., financial fraud detection and the like). In this exemplary case, an insurance provider claimant monitoring system 100 includes an adjuster interface engine 102 that provides insurance adjusters a user interface to manage the monitoring functions of monitoring system 100 for their particular claimants. For example, the adjuster interface engine 102 provides insurance adjusters an interface to create, review, and modify queries of claimants' social media data in multiple social media platforms 120 so as to focus the hits/responses received to those hits/responses that are more likely to reveal activity that could be indicative of a fraudulent insurance claim, and to display such hits/responses preferably in chronological order as they were generated on the claimant's varied social media profiles. The insurance provider claimant monitoring system 100 also provides a management reporting engine 104 allowing manager-level users of the system to monitor their adjusters' use of the system, including by generating reports on individual adjuster's use and compliance with the insurance provider's business rules concerning claimant monitoring, and by generating reports on overall hits/responses for the respective insurance provider 140. The insurance provider claimant monitoring system 100 also includes an electronic claimant profile data collection 106, which includes identifying information about claimants, details regarding their particular claim, and information identifying and allowing access to their electronic social media profiles.

The insurance provider claimant monitoring system 100 further includes a monitoring engine 108 configured to implement instructions from individual adjusters to monitor specific claimants' social media profiles, and to collect, analyze, and report back on relevant data that is responsive to such adjusters' queries and potentially indicative of fraudulent insurance claims.

Insurance provider claimant monitoring system 100 preferably communicates with a variety of social media platforms 120, such as (by way of non-limiting example) FACEBOOK, TWITTER, GOOGLE+ and the like, across a computer network 130 such as a wide area network such as the Internet. Insurance providers 140 (or other service providers) likewise preferably communicate with monitoring system 100 across computer network 130.

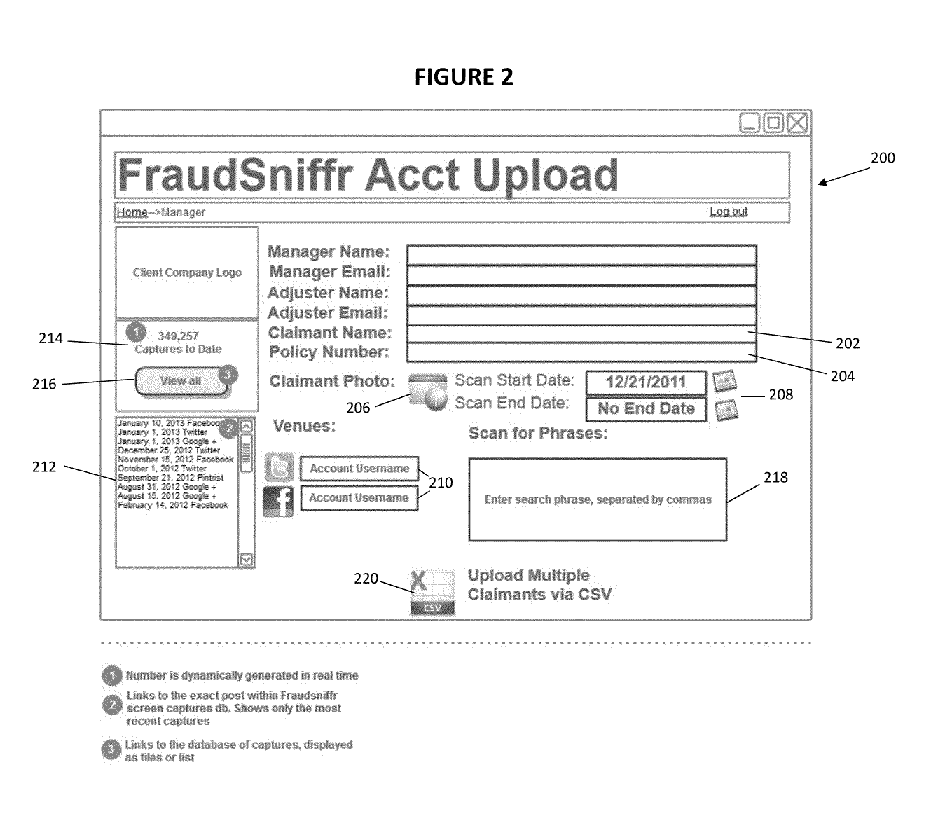

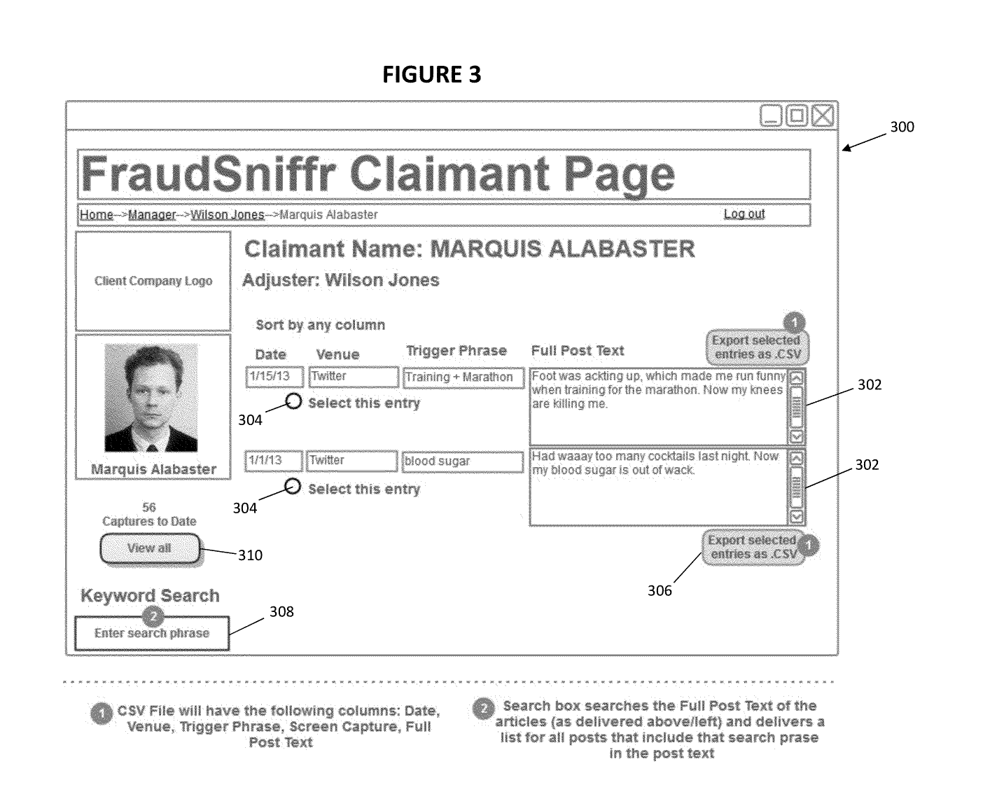

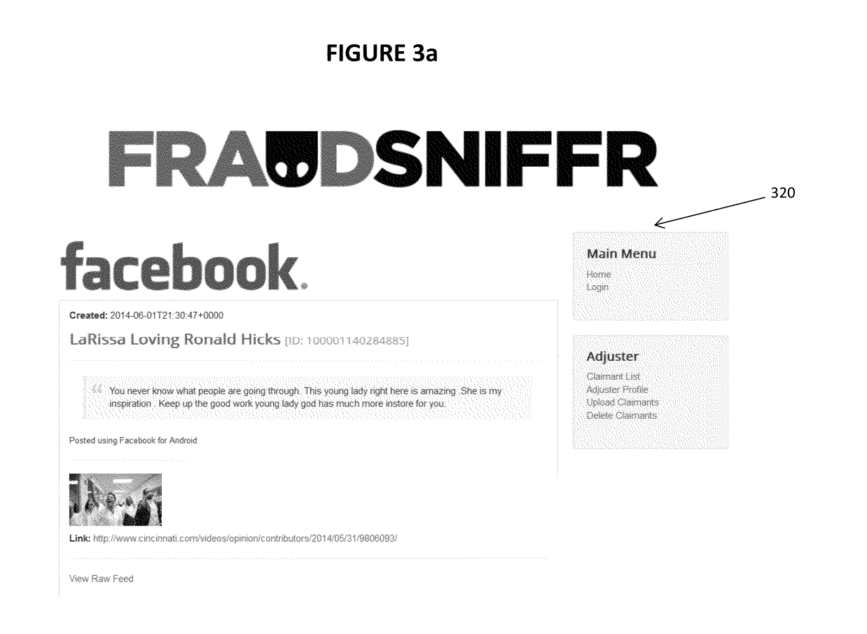

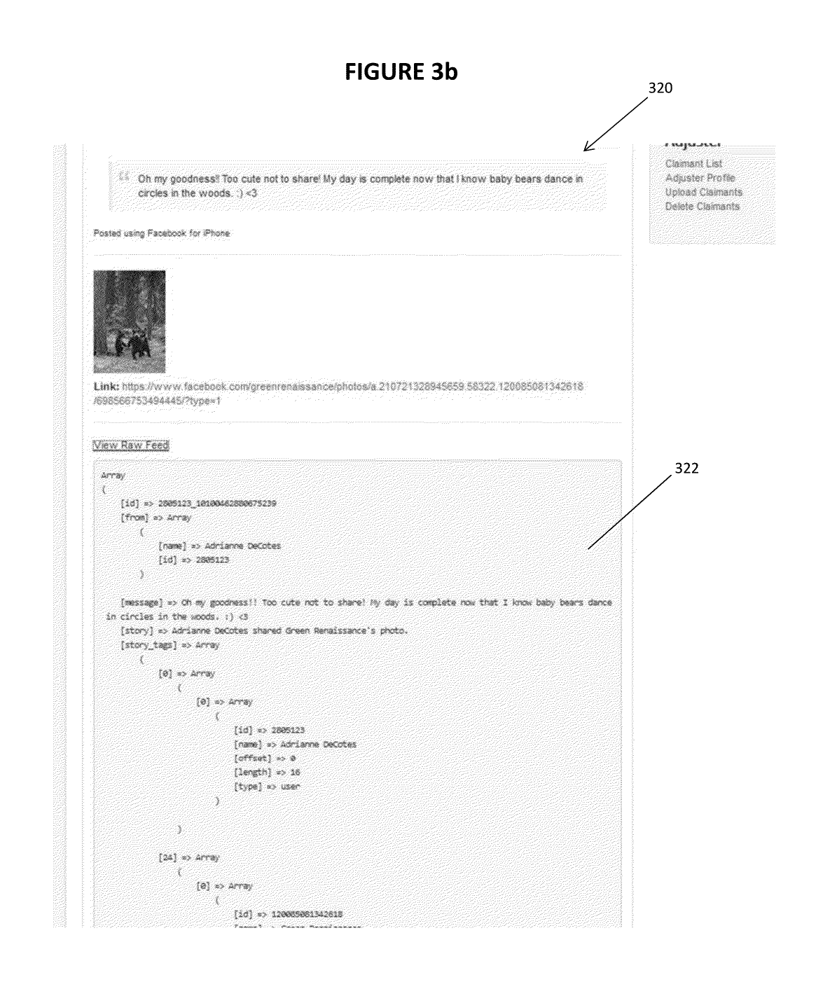

In use of the insurance provider claimant monitoring system 100, an adjuster may interact with adjuster interface engine 102 to setup or modify an electronic claimant profile. An exemplary claimant profile setup screen 200 is shown in FIG. 2, which allows an adjuster to add or edit claimant information, including their name 202, insurance policy number 204 or other identifying information (e.g., loan account number, etc.), their photograph 206, the dates 208 during which such claimant's social media profiles are to be monitored, and the claimant's specific usernames 210 on those social media platforms 120 that the system will monitor. Preferably, the monitoring of an individual claimant's social media profiles will continue throughout the life of the claimant's insurance claim, the life of a customer's loan, or other such period in which the service provider 140 provides a service to the customer. The claimant profile setup screen 200 may also include a listing of captured postings 212 from the claimant's monitored social media profiles (the captured postings comprising postings that are responsive to the system's queries for indications of potential fraud, along with the metadata associated with such captured postings), preferably listed in chronological order, and preferably configured as hyperlinks to the claimant's individual monitoring page 300 (FIG. 3) that shows the full text, and preferably the captured metadata, of such post. The claimant profile setup screen 200 may also display a dynamic, real-time display 214 of the number of claimant posts that the system has captured to date (for example, for all monitored claimants for a particular insurance provider 140, or for the particular claimant whose setup screen is currently displayed), and an electronic “VIEW ALL” button 216 that, when initiated, will display all captures counted in display 214, preferably displayed as tiles or a list.

The claimant profile setup screen 200 may further provide a data input window 218 in which an adjuster may input particular, customized search phrases that the monitoring engine will search for in the claimant's monitored social media profiles. However, upon creation of an electronic claimant profile, the system preferably populates such profile with default “crime specific” fraud phrases that would generally be applicable to a variety of situations. For example, a collection of worker's compensation fraud phrases could deliver posts containing (and by way of non-limiting example) “blood pressure,” “puke,” “cocaine,” “marathon,” “painting ceilings,” “bed and breakfast,” “bus tour,” “Las Vegas,” etc. Of course, other terms may be used and will be apparent to those skilled in the art as being calculated to suggest potentially fraudulent claims or representations by customers.

Once the adjuster has completed entering and/or updating such data, it is preferably saved and stored in electronic claimant profiles 106. Optionally, the claimant profile setup screen may provide a link 220 engaging a spreadsheet upload function in which the adjuster may upload multiple electronic claimant profiles in a single action.

With reference to FIG. 3, the claimant's individual monitoring page 300 displays all hits/responses 302 that the monitoring engine 108 receives for the selected claimant, and presents them preferably in chronological order. Such chronological presentation creates a clear, simple organization to aid an insurance company or other service provider when, for instance, a claim fraud case proceeds to litigation. The adjuster may further refine the hits/responses by selecting only the hits relevant to a particular part of the investigation, and download a separate list of selected items.

More particularly, after the claimant's electronic claimant profile is generated identifying their social media platforms 120 (and preferably the necessary user identifying information for each such platform), which may be provided by the claimant and verified by the insurance company, or through investigation such as by searching social media sites for the claimant's name, or through use of a private investigator or outside investigative service, the monitoring engine 108 will continuously monitor each identified social media platform 120 for the particular claimant in real time, filtering all future posts made by the claimant using the fraud search phrases attached to that claimant's electronic claimant profile, which might include phrases such as “hiking,” “bicycling,” “skipped my medication,” or other words or phrases calculated to suggest a possible fraudulent insurance claim. All hits/responses 302 (i.e., those posts that contain a fraud search phrase) are then preferably simultaneously archived, for instance in the electronic claimants profiles 106, and preferably in chronological order for that claimant. Such archive may thereafter be reviewed by interested persons, such as the assigned adjuster, management, or others (such as for purposes of generating evidence for use in fraudulent insurance claim litigation).

If the adjuster sees a particular hit/response of immediate interest, they may click to “view the full post” (such as, by way of non-limiting example, by clicking on hyperlinked text in the “Full Post Text” window), which in turn will display to the user a full post display page 320, as shown in FIG. 3a. Full post display page 320 may include a screen capture image 322 from the claimant's social media platform that includes the particular post 324 that was copied and added as a hit/response 302 to the claimant's electronic claimant profile. As shown in FIG. 3a, full post display page 320 provides a formatted document that preferably includes at least the name of the social media platform, the date captured, the content of the post, and any photos included in the post. This formatted view is included to assist employees at the service provider who have social media web sites blocked by their systems administrators. In this way, all employees in the fraud unit within the service providers will be able to use this service, regardless of access to social media web sites. This document may then be added to the customer's file for general review in the future.

Preferably, and as shown in FIG. 3b, full post display page 320 will also include a display of the metadata 322 associated with the post, which metadata is captured along with the full post. The metadata 322 may be used to confirm the source of the post and the date on which it was generated, in turn helping to establish the veracity of the post as evidence in a legal proceeding, such as an insurance claim fraud investigation and hearing.

With continued reference to FIG. 3, for each hit/response 302 produced on the claimant's individual monitoring page 300, a “SELECT THIS ENTRY” button 304 may be provided allowing a user to select such entry for export to a spreadsheet for further analysis, reporting, or archiving. An “EXPORT SELECTED ENTRIES” button 306 may also be provided to initiate an exporting function that will export the selected records to such a spreadsheet, which will preferably record at least the date, social media platform, trigger phrase (i.e., the search phrase that yielded the associated hit/response), screen capture, and full post text for the subject hit/response 302. Further, the claimant's individual monitoring page 300 may provide a “KEYWORD SEARCH” input window 308, allowing a user (e.g., an adjuster or manager) to input terms that may be searched in the text of the claimant's captured social media posts 302. The system will then deliver a list to such user of all posts that include that search phrase in the post text.

Still further, the claimant's individual monitoring page 300 may provide a link 310 to all previously captured social media posts for that claimant, which when engaged by the user will present that complete listing to the user.

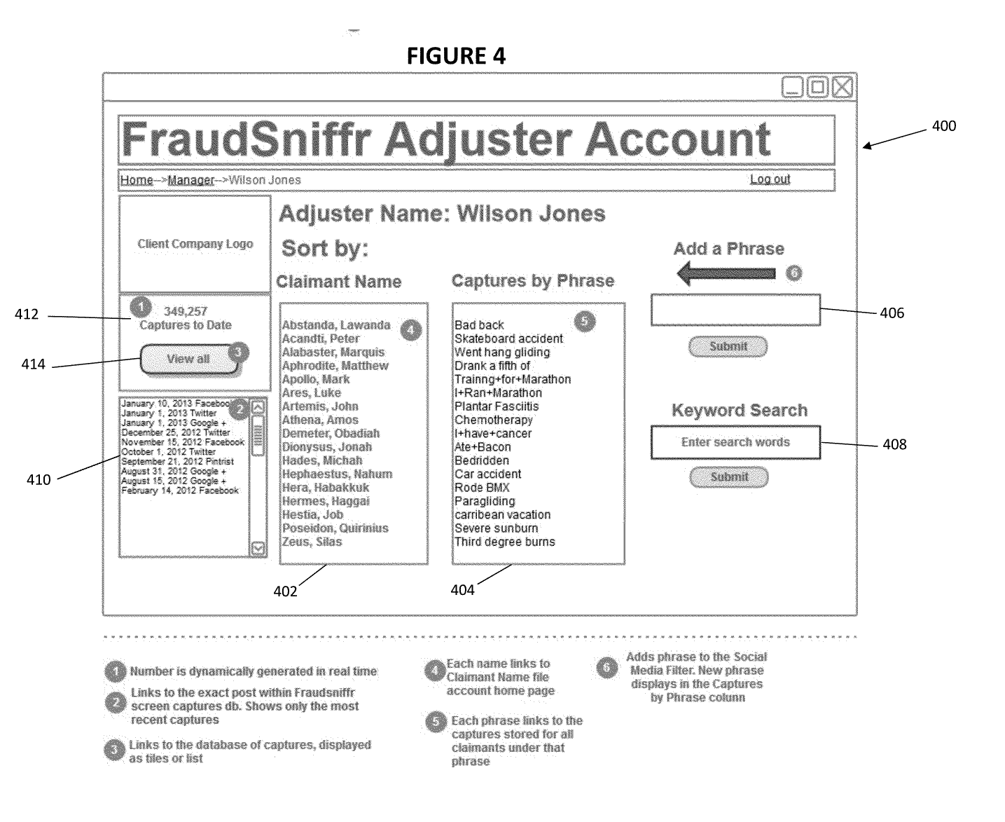

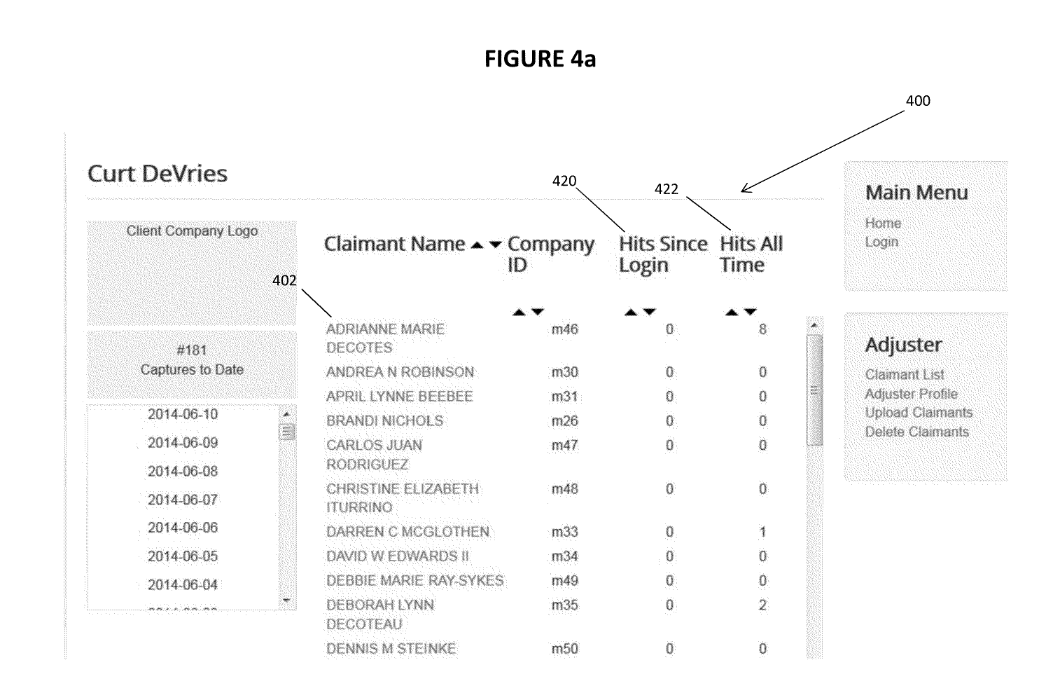

FIG. 4 is an exemplary adjuster user interface screen 400 that may be generated by adjuster interface engine 102, and allows an adjuster to explore data associated with various claimants that are monitored by the system. The user interface provided by the adjuster user interface screen 400 allows an adjuster to sort data by claimant name or by key phrases, and to search by keyword and to add terms or phrases that they wish to search across all of their assigned claimants. For these purposes, the adjuster user interface screen 400 provides a listing 402 of claimant names, with each name in the list comprising an electronic link to the individual electronic claimant profile associated with such name. Likewise, the adjuster user interface screen preferably provides a listing 404 of search phrases that the monitoring engine 108 will use to search claimants' social media postings, with each search phrase linking to the captures for that claimant (i.e., the data captured from each of the adjuster's assigned claimants that includes the particular search phrase). An “ADD A PHRASE” text window 406 may be used to enter additional search phrases to the listing, thus allowing the adjustor to tailor the hits/responses that he or she receives, and to conform their searches to the particulars of their claimants' cases. Likewise, a “KEYWORD SEARCH” window 408 may be provided to enter specific keywords that the particular adjuster may wish to search in hits/responses received for their assigned claimants, or optionally for all claimants of an insurance provider 140 that are monitored by the system.

As with the claimant profile setup screen of FIG. 2, the adjuster user interface screen may also provide a listing 410 of the most recent hits/responses received for the adjuster's assigned claimants (preferably presented in chronological order), each of which is preferably configured as a hyperlink to the associated claimant's individual monitoring page. The adjustor user interface screen also preferably displays a dynamic, real-time display 412 of the number of claimant posts that the system has captured for a particular insurance provider 140 to date, and an electronic “VIEW ALL” button 414 that, when initiated, will display all hits/responses counted in display 412, preferably displayed as tiles or a list.

Additionally, and with reference to FIG. 4a, adjuster user interface screen 400 may include (either combined with the features shown in FIG. 4 or as a separate display) a count of hits/responses received for the adjuster's assigned claimants, preferably including both a listing 420 of hits/response counts since the last time the user logged onto the system, and a listing 422 of hits/response counts that the system has delivered since it was implemented for the assigned adjuster, each on a per-claimant basis.

Preferably, in addition to archiving hits/responses in a chronological listing for a given claimant, the monitoring engine 108 may also generate an email when a new hit/response is generated. That email may be sent to the adjuster to whom such claimant is assigned, including the particular social media posting that generated the hit/response 302, which the adjuster may then append to the claimant's file that is maintained by the insurance provider 140.

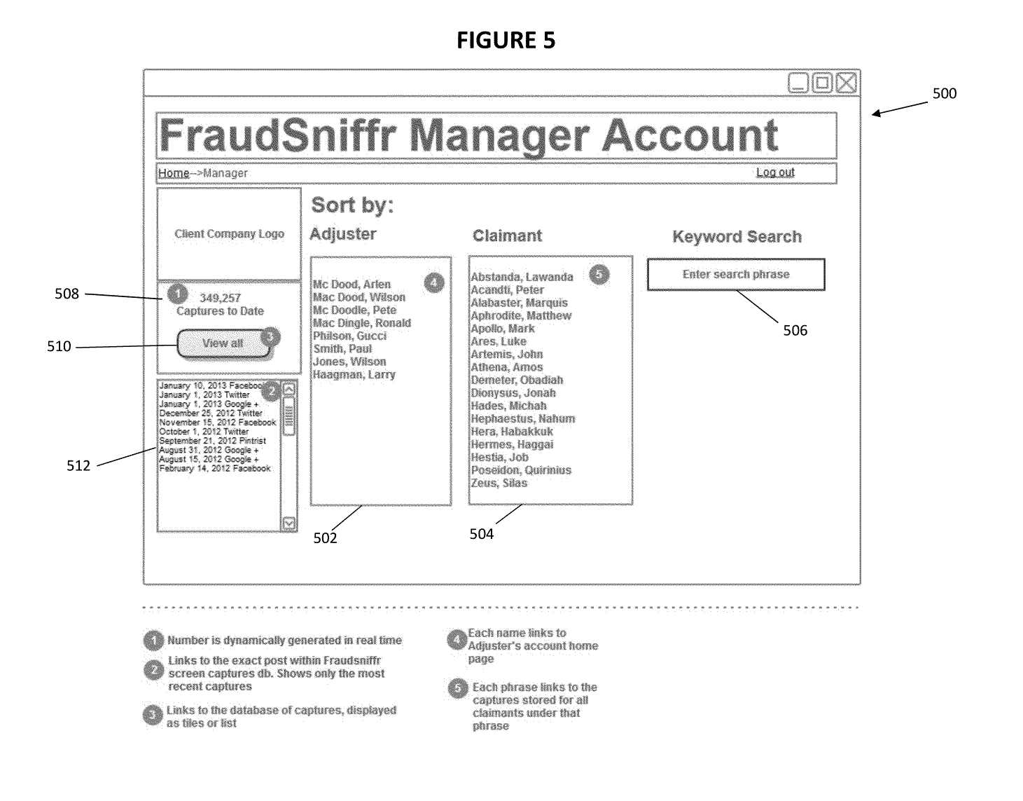

Next, FIG. 5 shows an exemplary manager user interface screen 500 that displays a number of hits/responses in a snapshot view, allows a manager from an insurance provider 140 to ensure that their claims adjusters are properly using the system, and allows such managers to sort data by adjuster name, claimant name, or key phrase. For these purposes, the manager user interface screen 500 provides a listing 502 of their claim adjusters using the system, and a listing 504 of claimants associated with each such adjuster. Each name in the adjuster listing 502 preferably provides an electronic link to that adjuster's home page, and each name in the claimant listing 504 preferably provides an electronic link to that claimant's individual monitoring page. A “KEYWORD SEARCH” text box 506 allows a manager to enter text to search all hits/responses associated with their list of adjusters and their assigned claimants. Likewise, the manager user interface screen 500 preferably again displays a dynamic real-time display 508 of the number of claimant posts that the system has captured for a particular insurance provider 140 to date, and an electronic “VIEW ALL” button 510 that, when initiated, will display all hits/responses counted in display 508, preferably displayed as tiles or a list. Similarly, the manager user interface screen 500 preferably again displays a listing 512 of the most recent hits/responses received for a selected claimant under a selected adjuster (preferably presented in chronological order), each of which is preferably configured as a hyperlink to the associated claimant's individual monitoring page 300, thus providing the manager a convenient display for easily determining their adjuster's compliance with the insurance provider's policies for using the system.

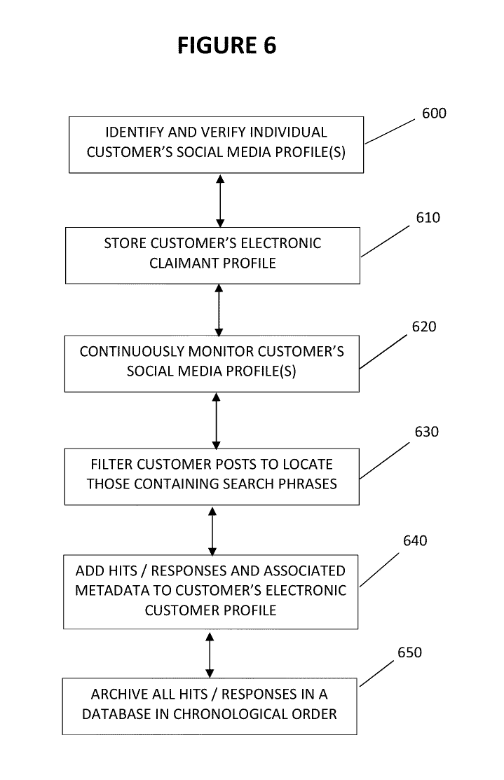

An overall method employing the above-described system is shown in the flowchart of FIG. 6. At step 600, an individual customer's social media profile(s) is identified and verified. At step 610, the customer's electronic profile (such as that of an insurance claimant, loan applicant or recipient, etc.), including their social media profile, is stored by the system. At step 620, the system continuously monitors the customer's social media profile(s) in real time, analyzing all future posts made by the customer. At step 630, the monitoring engine filters customer posts in order to locate those posts containing search phrases that are calculated to suggest possible fraud (e.g., insurance claim fraud), such as (by way of non-limiting example) “hiking,” “bicycling,” “skipped my medication,” and the like. At step 640, a hit/response meeting the search phrase query is added to the customer's electronic customer profile, along with the metadata associated with that hit/response. Moreover, the system may generate and send an email message to the customer's assigned customer service representative, such as an insurance adjuster, that includes the customer's post, and the customer service representative may then append the post to the customer's file that is maintained by the service provider. Finally, at step 650, all hits/responses are archived in a database (e.g., electronic claimant profiles 106) in chronological order for review by management or for future litigation preparation.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

We claim:

1. A computer implemented service provider customer evaluation system, comprising:
a computer implemented monitoring engine having computer software code configured to:
receive electronic queries formatted to identify information in electronic posts within an electronic social media profile, which electronic social media profile is uniquely associated with a specific customer of a service provider, which information is contrary to information represented by said customer to said service provider and relevant to a service provided by said service provider to said customer;
continuously apply said queries to posts in said customer's social media profile;
receive responses to said queries of said posts in said customer's social media profile, said responses comprising one or more posts in said customer's social media profile containing information that is responsive to at least one of said queries;
capture metadata associated with each response; and
generate a listing of said responses to said queries.

2. The system of claim 1, wherein said responses further comprise text data that is copied from said one or more posts in said customer's social media profile containing information that is responsive to at least one of said queries.

3. The system of claim 2, wherein said listing comprises said responses arranged in chronological order.

4. The system of claim 2, wherein said responses further comprise one or more images associated with said one or more posts in said customer's social media profile containing information that is responsive to at least one of said queries.

5. The system of claim 1, wherein said computer software code is further configured to continuously apply said queries to said posts in said customer's social media profile in real time.

6. The system of claim 1, further comprising a computer implemented service provider interface engine having computer software code configured to:
display a customer detail page associated with said customer and including said listing of said responses to an employee user of said computer implemented service provider customer evaluation system.

7. The system of claim 6, wherein said service provider interface engine further comprises computer software code configured to:
prompt said employee user to enter a search phrase; and
search said listing of responses for responses that include said search phrase.

8. The system of claim 6, where said service provider interface engine further comprises computer software code configured to:
prompt said employee user to select one or more of said responses in said listing of responses; and
generate a report of said selected responses in a chronological listing, wherein each of said selected responses in said report includes at least text data that is copied from said one or more posts in said customer's social media profile containing information that is responsive to at least one of said queries, and a date on which each of said selected responses is captured from said customer's social media profile.

9. The system of claim 1, further comprising an electronic collection of electronic customer profiles, each said electronic customer profile associated with an individual customer of said service provider and comprising information identifying said customer and information identifying an electronic social media profile of said customer.

10. A computer implemented method for evaluating customers of a service provider, comprising the steps of:
receiving at a computer implemented monitoring engine queries formatted to identify information in electronic posts within an electronic social media profile, which electronic social media profile is uniquely associated with a specific customer of a service provider, which information is contrary to information represented by said customer to said service provider and relevant to a service provided by said service provider to said customer;
causing said monitoring engine to continuously apply said queries to posts in said customer's social media profile;
receiving at said monitoring engine responses to said queries of said posts in said customer's social media profile, said responses comprising one or more posts in said customer's social media profile containing information that is responsive to at least one of said queries and metadata associated with each such response; and
generating a listing of said responses to said queries.

11. The method of claim 10, wherein said responses further comprise text data that is copied from said one or more posts in said customer's social media profile containing information that is responsive to at least one of said queries.

12. The method of claim 11, wherein said listing comprises said responses arranged in chronological order.

13. The method of claim 11, wherein said responses further comprise one or more images associated with said one or more posts in said customer's social media profile containing information that is responsive to at least one of said queries.

14. The method of claim 10, further comprising the step of continuously applying said queries to said posts in said customer's social media profile in real time.

15. The method of claim 10, further comprising the steps of:
displaying at a computer implemented service provider interface engine a customer detail page associated with said customer and including said listing of said responses to an employee user of said computer implemented service provider customer evaluation system.

16. The method of claim 15, further comprising the steps of:
causing said service provider interface engine to prompt said employee user to enter a search phrase; and
in response to receiving said search phrase, searching said listing of responses for responses that include said search phrase.

17. The method of claim 15, further comprising the steps of:
causing said service provider interface engine to prompt said employee user to select one or more of said responses in said listing of responses; and
in response to said selection of one or more of said responses, generating a report of said selected responses in a chronological listing, wherein each of said selected responses in said report includes at least text data that is copied from said one or more posts in said customer's social media profile containing information that is responsive to at least one of said queries, and a date on which each of said selected responses is captured from said customer's social media profile.

18. The method of claim 10, further comprising the step of:
providing an electronic collection of electronic customer profiles, each said electronic customer profile associated with an individual customer of said service provider and comprising information identifying said customer and information identifying an electronic social media profile of said customer.
